(19) United States
(12) Patent Application Publication
(10) Pub. No.: US 2019/0297624 A1
(43) Pub. Date: Sep. 26, 2019

(54) WIRELESS DEVICE, COMMUNICATION METHOD THAT USE PREDETERMINED FREQUENCY

(71) Applicant: JVC KENWOOD Corporation, Yokohama-shi (JP)

(72) Inventor: Eiiti HOSONO, Yokohama-shi (JP)

(21) Appl. No.: 16/357,419

(22) Filed: Mar. 19, 2019

(30) Foreign Application Priority Data
Mar. 20, 2018 (JP) 2018-051872

(51) Int. Cl. H04W 72/04; H04W 72/02

(52) U.S. Cl. CPC H04W 72/0453; H04W 4/10; H04W 72/02

(57) ABSTRACT

A communication unit performs, in a state where communication is not being performed, a first session of communication by using a first frequency. A determination unit determines whether a second frequency different from the first frequency is available for use after the first session of communication in the communication unit is ended. When the determination unit determines that the second frequency is available for use, the communication unit uses the second frequency to perform a second session of communication. When the determination unit determines that the second frequency is not available for use, the communication unit uses the first frequency to perform the second session of communication.

### CROSS-REFERENCE TO RELATED APPLICATION

This application is based upon and claims the benefit of priority from the prior Japanese Patent Application No. 2018-51872, filed on Mar. 20, 2018, the entire contents of which is incorporated herein by reference.

### BACKGROUND OF THE INVENTION

### 1. Field

The present invention relates to communication technology and, more particularly, a wireless device and a communication method that use a predetermined frequency.

### 2. Description of the Related Art

In the case where two frequencies can be defined as the reception frequency, one of the frequencies is defined as the reception frequency. In the event that there is an incoming call at the reception frequency thus defined, that reception frequency continues to be used for reception. In the absence of an incoming call at the reception frequency thus thus defined, the reception frequency is switched to the other frequency. In the event that there is an incoming call at the reception frequency switched into use, that reception frequency continues to be used for reception (see, for example, patent document 1).

[patent document 1] JP5-252073

In a communication system capable of executing a mode in which two wireless devices communicate directly (hereinafter, referred to as “direct communication”) and a mode in which two wireless devices communicate via a base station device (hereinafter, referred to as “indirect communication”), compatibility between the two modes of communication is called for. To simplify the compatibility with these modes of communication, the frequency at which the base station device receives a signal and the frequency at which the wireless device receives a signal are defined separately. For this reason, only the frequency at which the wireless device receives a signal is used for direct communication. As a result, two sessions of direct communication are not concurrently performed even when indirect communication is not performed.

### SUMMARY OF THE INVENTION

A wireless device according to an embodiment includes: a communication unit that performs, in a state where communication is not being performed, a first session of communication by using a first frequency; and a determination unit that determines whether a second frequency different from the first frequency is available for use after the first session of communication in the communication unit is ended. When the determination unit determines that the second frequency is available for use, the communication unit uses the second frequency to perform a second session of communication, and, when the determination unit determines that the second frequency is not available for use, the communication unit uses the first frequency to perform the second session of communication.

Another embodiment relates to a communication method. The method includes: performing, in a state where communication is not being performed, a first session of communication by using a first frequency; determining whether a second frequency different from the first frequency is available for use after the first session of communication is ended; using the second frequency to perform a second session of communication when it is determined that the second frequency is available for use; and using the first frequency to perform the second session of communication when it is determined that the second frequency is not available for use.

Optional combinations of the aforementioned constituting elements, and implementations of the embodiments in the form of methods, apparatuses, systems, recording mediums, and computer programs may also be practiced as additional modes of the embodiments.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of a communication system according to the embodiment;

FIG. 2 is a sequence diagram showing the steps in the indirect communication mode;

FIG. 3 is a sequence diagram showing the steps in the direct communication mode;

FIG. 4 shows a configuration of the wireless device according to the embodiment;

FIG. 5 is a sequence diagram showing the steps of communication in the communication system according to the embodiment;

FIG. 6 is a flowchart showing the steps of communication in the wireless device of FIG. 4.

### DETAILED DESCRIPTION

The invention will now be described by reference to the preferred embodiments. This does not intend to limit the scope of the present invention, but to exemplify the invention.

A summary of the prevent invention will be given before describing the invention in specific detail. An embodiment relates to a communication system capable of performing direct communication and indirect communication. An example of a communication system is a business wireless system. PushtoTalk (PTT) communication will be described by way of example. In PTT, a user presses a button in a wireless device to start a talk and releases the button when the talk is ended. While the button is being pressed, the wireless device transmits a sound signal, and another terminal device receives sound data. The other wireless device plays back the sound. In the case of the direct communication mode, the sound signal is directly transmitted from the wireless device to the other wireless device. In the case of the indirect communication mode, the wireless device transmits the sound signal to the other wireless device via a base station device. To simplify the standby process in the wireless device that should be compatible with the direct communication mode and the indirect communication mode, the frequency that each wireless device is capable of receiving is uniquely defined. For example, the wireless devices receive a signal at the first frequency.

To describe it more specifically, the wireless devices transmit a signal at the first frequency and receive a signal at the first frequency in the direct communication mode. Meanwhile, the wireless devices transmit a signal at the second frequency, and the base station device receive a signal at the second frequency in the indirect communication mode. Further, the base station device transmits a signal at the first frequency, and the wireless devices receive a signal at the first frequency. In other words, two frequencies are used in the indirect communication mode, but only one frequency is used in the direct communication mode. Consequently, while a set of direct communication is being performed, another set of direct communication cannot be performed even if indirect communication is not performed, i.e., even if the second frequency is not used. In this background, it is required to improve the efficiency of using frequencies while also simplifying the standby process.

As in the related art, the wireless devices of the communication system according to the embodiment use the first frequency to start the first session of communication in the direct communication mode. At a point of time when the first communication session is ended, the wireless devices that have performed direct communication examines whether the second frequency is already used. When the second frequency is not used, these wireless devices use the second frequency to perform the second session of communication. When the second frequency is used, on the other hand, these wireless devices use the first frequency to perform the second session of communication. By allowing the second session of communication to be performed by using the second frequency, the other wireless device can continue to use the first frequency to start the first session of communication in the direct communication mode.

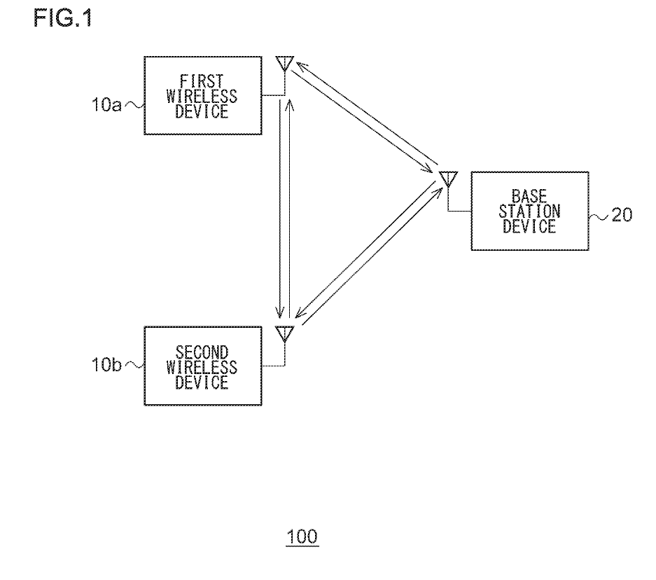

FIG. 1 shows a configuration of a communication system 100. As mentioned above, the communication system 100 is exemplified by a business wireless system. The communication system 100 includes a first wireless device 10a and a second wireless device 10b, which are generically referred to as wireless devices 10, and a base station device 20. The number of wireless devices 10 is not limited to “2”. Each wireless device 10 is a terminal device compatible with PTT and could originate a sound signal or receive a sound signal. Identification information (hereinafter, referred to as “UID”) for identifying the wireless device 10 is assigned each wireless device 10. For example, the UID of the first wireless device 10a is “10a”, and the UID of the second wireless device 10b is “10b”.

In the direct communication mode, the first wireless device 10a and the second wireless device 10b communicate directly without being mediated by the base station device 20. In other words, the sound signal transmitted from the first wireless device 10a is received by the second wireless device 10b, and the sound signal transmitted from the second wireless device 10b is received by the first wireless device 10a. In the indirect communication mode, on the other hand, the first wireless device 10a and the second wireless device 10b communicate via the base station device 20. In other words, the sound signal transmitted from the first wireless device 10a is received by the second wireless device 10b via the base station device 20. Further, the sound signal transmitted from the second wireless device 10b is received by the first wireless device 10a via the base station device 20.

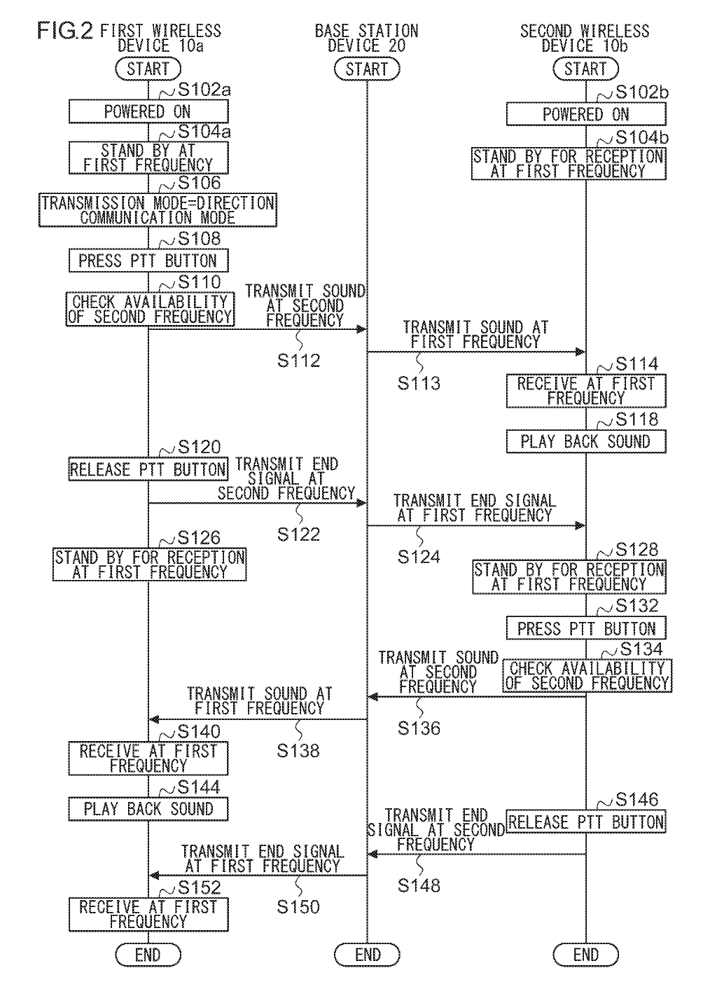

FIG. 2 is a sequence diagram showing the steps in the indirect communication mode. The first wireless device 10a and the second wireless device 10b are powered on (S102a, S102b). The first wireless device 10a and the second wireless device 10b stand by for reception at the first frequency (S104a, S104b). The transmission mode is set to the indirect communication mode in the first wireless device 10a (S106). The PTT button is pressed in the first wireless device 10a (S108). The first wireless device 10a checks whether the second frequency is available for use (S110). The first wireless device 10a transmits the sound signal at the second frequency (S112), and the base station device 20 transmits the sound signal at the first frequency (S113). The second wireless device 10b receives the sound signal at the first frequency (S114). The second wireless device 10b plays back the sound (S118). The PTT button is released in the first wireless device 10a (S120). The first wireless device 10a transmits an end signal at the second frequency (S122), and the base station device 20 transmits the end signal at the first frequency (S124). The first wireless device 10a and the second wireless device 10b stand by for reception at the first frequency (S126, S128).

The PTT button is pressed in the second wireless device 10b (S132). The second wireless device 10b checks whether the second frequency is available for use (S134). The second wireless device 10b transmits the sound signal at the second frequency (S136), and the base station device 20 transmits the sound signal at the first frequency (S138). The first wireless device 10a receives the sound signal at the first frequency (S140). The first wireless device 10a plays back the sound (S144). The PTT button is released in the second wireless device 10b (S146). The second wireless device 10b transmits an end signal at the second frequency (S148), and the base station device 20 transmits the end signal at the first frequency (S150). The first wireless device 10a receives the end signal at the first frequency (S152).

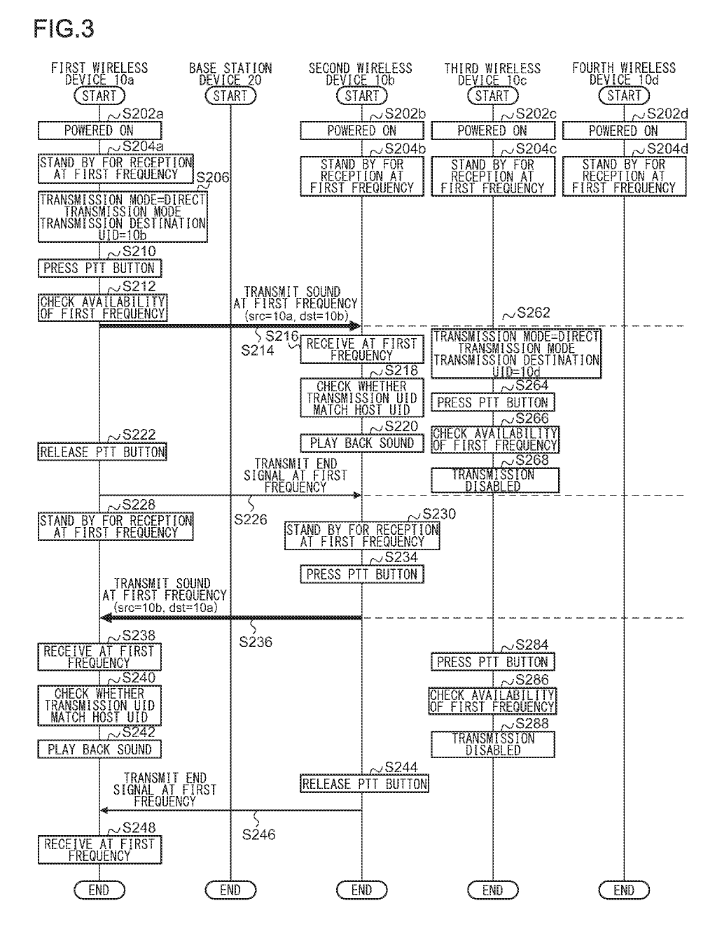

FIG. 3 is a sequence diagram showing the steps in the direct communication mode. The illustrated mode corresponds to the direct communication mode performed in the related art. The first wireless device 10a, the second wireless device 10b, the third wireless device 10c, and the fourth wireless device 10d are powered on (S202a, S202b, S202c, S202d). The first wireless device 10a, the second wireless device 10b, the third wireless device 10c, and the fourth wireless device 10d stand by for reception at the first frequency (S204a, S204b, S204c, S204d). The transmission mode is set to the direct communication mode, and the transmission destination UID is set to 10b in the first wireless device 10a (S206). The PTT button is pressed in the first wireless device 10a (S210). The first wireless device 10a checks whether the first frequency is available for use (S212). The first wireless device 10a transmits the sound signal at the first frequency (S214), and the second wireless device 10b receives the sound signal at the first frequency (S216). The second wireless device 10b checks whether the transmission destination UID and the host UID match (S218). When the UIDs match, the second wireless device 10b plays back the sound (S220). The PTT button is released in the first wireless device 10a (S222). The first wireless device 10a transmits an end signal at the first frequency (S226). The first wireless device 10a and the second wireless device 10b stand by for reception at the first frequency (S228, S230).

The PTT button is pressed in the second wireless device 10b (S234). The second wireless device 10b transmits the sound signal at the first frequency (S236). The first wireless device 10a receives the sound signal at the first frequency (S238). The first wireless device 10a checks whether the transmission destination UID and the host UID match (S240). When the UIDs match, the first wireless device 10a plays back the sound (S242). The PTT button is released in the second wireless device 10b (S244). The second wireless device 10b transmits an end signal at the first frequency (S246). The first wireless device 10a receives the end signal at the first frequency (S248).

In this situation, the transmission mode is set to the direct communication mode, and the transmission destination UID is set to 10d in the third wireless device 10c (S262). The PTT button is pressed in the third wireless device 10c (S264). The third wireless device 10c checks whether the first frequency is available for use (S266). Since the first frequency is used for direct communication between the first wireless device 10a and the second wireless device 10b, transmission from the third wireless device 10c is disabled (S268). Following this, the PTT button is pressed in the third wireless device 10c (S284). The third wireless device 10c checks whether the first frequency is available for use (S286). Since the first frequency is used for direct communication between the first wireless device 10a and the second wireless device 10b in this case, too, transmission from the third wireless device 10c is disabled (S288). In other words, only the first frequency is used in the direct communication mode so that two sessions of direct communication cannot take place at the same time.

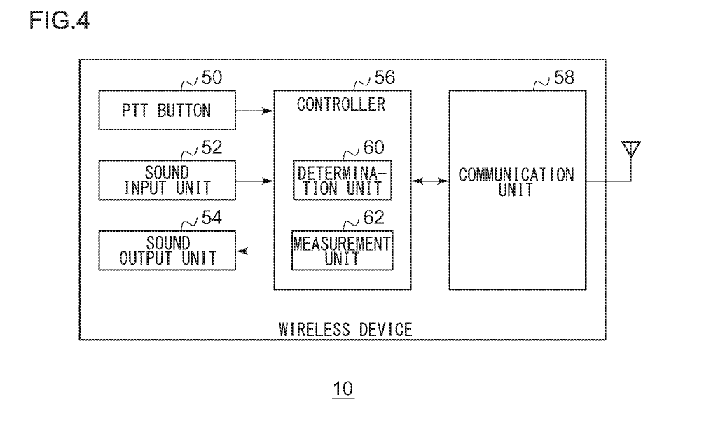

FIG. 4 shows a configuration of the wireless device 10. The wireless device 10 includes a PTT button 50, a sound input unit 52, a sound output unit 54, a controller 56, and a communication unit 58. The controller 56 includes a determination unit 60 and a measurement unit 62. The PTT button 50 is switched into a pressed state and a released state (non-pressed state) according to the user's operation. The sound input unit 52 is comprised of, for example, a microphone, collects the user's speech, and converts the speech into an electrical signal. The sound output unit 54 is comprised of, for example, a speaker. The sound output unit 54 plays back the sound from the controller 56.

In the event that the pressed state of the PTT button 50 is detected, the determination unit 60 in the wireless device 10 on the transmission side measures the power at the first frequency for a predetermined period of time via the communication unit 58. When the measured power is smaller than a threshold value, the determination unit 60 determines that the first frequency is available for use. When the measured power is equal to or larger than the threshold value, on the other hand, the determination unit 60 determines that the first frequency is not available for use. When the determination unit 60 determines that the first frequency is available for use, the controller 56 generates a sound signal to include an electric signal received from the sound input unit 52 while the PTT button 50 is detected as being in a pressed state. In this process, the controller 56 includes the transmission destination UID and the transmission source UID in the sound signal. Further, the controller 56 includes information indicating whether the communication is direct communication or indirect communication in the sound signal. The UID for identifying the host wireless device 10 is used as the transmission source UID. The controller 56 outputs the sound signal to the communication unit 58, and the communication unit 58 transmits the sound signal at the first frequency.

Meanwhile, the communication unit 58 in the wireless device 10 on the reception side stands by for reception at the first frequency. Upon receipt of a sound signal at the first frequency, the communication unit 58 outputs the sound signal to the controller 56. Upon receipt of the sound signal from the communication unit 58, the controller 56 checks whether the transmission destination UID included in the sound signal matches the UID of the host device. When the UIDs do not match, the process is ended. When the UIDs match, the controller 56 outputs the sound included in the sound signal to the sound output unit 54. In other words, the communication unit 58 in a state where communication is not being performed performs the first session of communication using the first frequency. Such a process is continued while the communication unit 58 of the wireless device 10 on the reception side is receiving the sound signal, i.e., while the PTT button 50 of the wireless device 10 on the transmission side is being pressed.

Upon detection of the released state of the PTT button 50 in the wireless device 10 on the transmission side, the controller 56 generates a signal for indicating the end of transmission of the sound signal (hereinafter, referred to as “end signal”). The end signal includes the same transmission destination UID and transmission source UID as those of the sound signal. The end signal also includes information indicating whether the communication is direction communication or indirect communication. The controller 56 outputs the end signal to the communication unit 58, and the communication unit 58 transmits the end signal at the first frequency. When the communication unit 58 on the reception side receives the end signal, the controller 56 ends communication. This ends the first session of communication in the communication units 58 in the wireless devices 10 on the transmission side and the reception side.

In the wireless devices 10 on the transmission side and the reception side, the determination unit 60 measures the power at the second frequency for a predetermined period of time via the communication unit 58 after the first session of communication is ended. When the measured power is smaller than a threshold value, the determination unit 60 determines that the second frequency is available for use. When the measured power is equal to or larger than the threshold value, on the other hand, the determination unit 60 determines that the second frequency is not available for use. The second frequency is different from the first frequency, and a determination as to whether the second frequency is available for use is made as described above.

When the determination unit 60 determines that the second frequency is not available for use, the first frequency is used again, and the second session of communication is performed as described above. The second session of communication refers to direction communication performed between the wireless device 10 on the transmission side and the wireless device 10 on the reception side in the first session of communication, but the wireless device 10 on the transmission side and the wireless device 10 on the reception side may replace each other. It should be noted that communication other than “the second session of communication” includes communication in the indirect communication mode, and communication in the direct communication mode in which the transmission destination UID or the destination UID of the first session of communication is not included in the transmission destination UID. In this case, communication is performed at the first frequency even if the second frequency is available for use.

When the determination unit 60 determines that the second frequency is available for use, the measurement unit 62 starts time measurement. When the controller 56 of one of the wireless devices 10 detects the pressed state of the PTT button 50 before the timer expires, the controller 56 generates a sound signal to include an electric signal received from the sound input unit 52. The sound signal is for the second session of communication. The controller 56 outputs the sound signal to the communication unit 58, and the communication unit 58 transmits the sound signal at the second frequency. The communication unit 58 of the other wireless device 10 stands by for reception at the second frequency until the timer expires. Upon receipt of the sound signal at the second frequency, the communication unit 58 outputs the sound signal to the controller 56. The steps following this are as described above. In other words, when the determination unit 60 determines that the second frequency is available for use, the communication unit 58 uses the second frequency to start the second session of communication before the timer in the measurement unit 62 expires. When the time in the measurement unit 62 expires, the controllers 56 and the communication units 58 of both wireless devices 10 return the system to a state where communication is not performed.

In the third and subsequent sessions of communication, the same steps as performed in the second session are performed. In particular, when the second session of communication using the first frequency is ended in the communication unit 58, the determination unit 60 determines whether the second frequency is available for use. When the determination unit 60 determines that the second frequency is available for use, the communication unit 58 performs the third session of communication using the second frequency when the timer has not expired. When the determination unit 60 determines that the second frequency is not available for use, on the other hand, the communication unit 58 uses the first frequency to perform the third session of communication.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

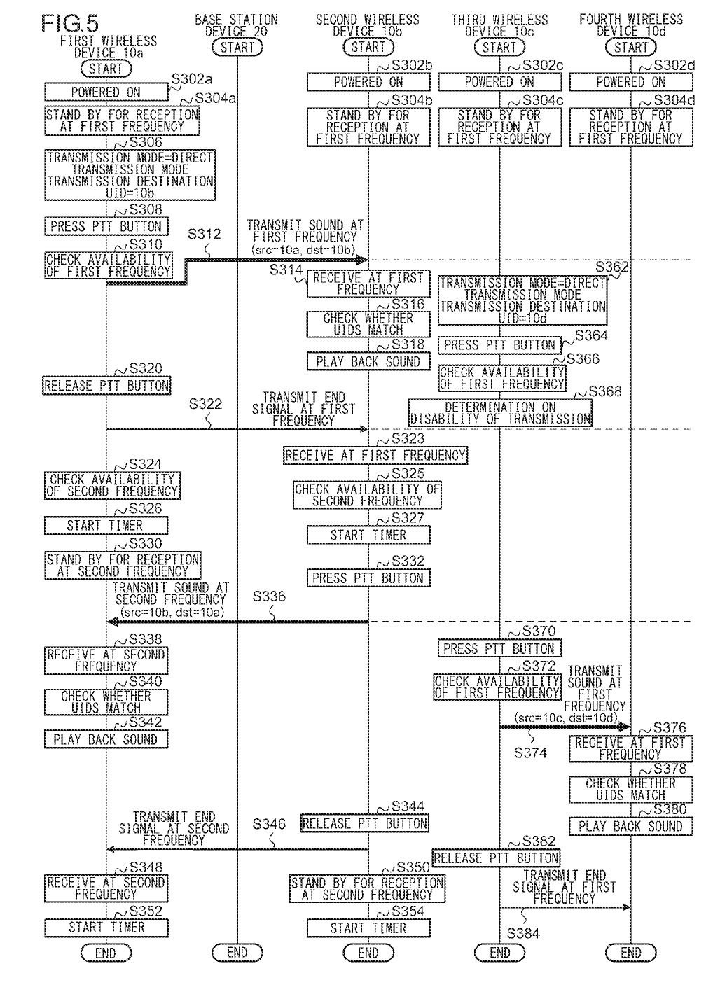

A description will be given of the operation of the communication system 100 configured as described above. FIG. 5 is a sequence diagram showing the steps of communication in the communication system 100. The first wireless device 10a, the second wireless device 10b, the third wireless device 10c, and the fourth wireless device 10d are powered on (S302a, S302b, S302c, S302d). The first wireless device 10a, the second wireless device 10b, the third wireless device 10c, and the fourth wireless device 10d stand by for reception at the first frequency (S304a, S304b, S304c, S304d). The transmission mode is set to the direct communication mode, and the transmission destination UID is set to 10b in the first wireless device 10a (S306). The PTT button is pressed in the first wireless device 10a (S308). The first wireless device 10a checks whether the first frequency is available for use (S310). The first wireless device 10a transmits the sound signal at the first frequency (S312). In other words, when the first frequency is not used, the first wireless device 10a transmits the sound signal collected by pressing the PTT button 50 of the first wireless device 10a by using the first frequency. Further, the transmission source UID (10a, which is the UID of the first wireless device 10a) and the transmission destination UID (10b, which is the UID of the second wireless device 10b) are transmitted along with the sound. When the first frequency is being in use, transmission is not performed, and the user is notified accordingly.

The second wireless device 10b receives the sound signal at the first frequency (S314). The second wireless device 10b checks whether the transmission destination UID and the host UID match (S316). When the UIDs match, the second wireless device 10b plays back the sound included in the sound signal via the sound output unit 54 (S318). When the UIDs do not match, the sound is not played back. The PTT button is released in the first wireless device 10a (S320). The first wireless device 10a transmits an end signal at the first frequency (S322). The second wireless device 10b receives the end signal at the first frequency (S323). The first wireless device 10a and the second wireless device 10b check whether the second frequency is available for use (S324, S325). When the second frequency is available for use, the first wireless device 10a and the second wireless device 10b starts the timer (S326, S327). The first wireless device 10a stands by for reception at the second frequency (S330).

The PTT button 50 is pressed in the second wireless device 10b before the timer expires (S332). When the PTT button 50 is pressed after the timer expires, the sound signal may be transmitted in a predefined communication scheme. The second wireless device 10b transmits the sound signal at the second frequency (S336). It should be noted that the transmission source (src) UID (10b, which is the UID of the second wireless device 10b) and the transmission destination UID (10a, which is the UID of the first wireless device 10a) are included in the sound signal. The first wireless device 10a receives the sound signal at the second frequency before the timer expires (S338). When the timer has expired, the first wireless device 10a returns the frequency, at which the device stands by for reception, from the second frequency to the first frequency. S340-S354 are similar to S316-S327 so that a description will be omitted.

In this situation, the transmission mode is set to the direct communication mode, and the transmission destination UID is set to 10d in the third wireless device 10c (S362). The PTT button is pressed in the third wireless device 10c (S364). The third wireless device 10c checks whether the first frequency is available for use (S366). Since the first frequency is used for direct communication between the first wireless device 10a and the second wireless device 10b, transmission from the third wireless device 10c is disabled (S368). Following this, the PTT button is pressed in the third wireless device 10c (S370). The third wireless device 10c checks whether the first frequency is available for use (S372). The third wireless device 10c confirms that the first frequency is not use as the second frequency is being used. The third wireless device 10c transmits the sound collected by pressing the PTT button 50 by using the first frequency (S374). It should be noted that the transmission source UID (10c, which is the UID of the third wireless device 10c) and the transmission destination UID (10d, which is the UID of the fourth wireless device 10d) are included in the sound signal. S376-S384 are similar to S314-S322.

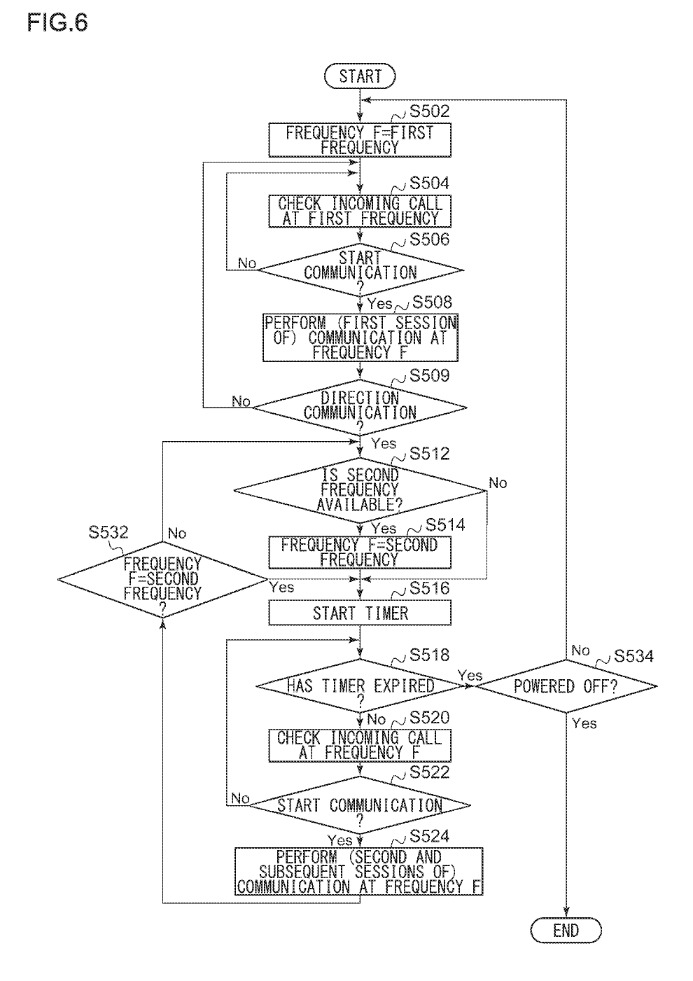

FIG. 6 is a flowchart showing the steps of communication in the wireless device 10. The communication unit 58 defines the value of a frequency F, which is a variable for storing the frequency used in communication, to be the first frequency (S502). The controller 56 and the communication unit 58 check an incoming call at the frequency F (S504). The controller 56 determines whether to start communication (S506). For example, the controller 56 determines to start communication when there is an incoming call or when the PTT button 50 is pressed. When communication is not started (No in S506), control is returned to step 504. When communication is started (Yes in S506), the communication unit 58 performs the first session of communication at the frequency F (S508). The first session of communication is ended upon the transmission or reception of an end signal.

When the communication is not direct communication (No in S509), control is returned to step 504. When the communication is direct communication (Yes in S509), the determination unit 60 determines whether the second frequency is available for use (S512). When the second frequency is available (Yes in S512), the communication unit 58 changes the value of the frequency F to the second frequency (S514). When the second frequency is not available (No in S512), the communication unit 58 does not change the value of the frequency F. The measurement unit 62 starts the timer (S516). The communication unit 58 determines whether the timer has expired (S518). When the timer has not expired (No in S518), the controller 56 and the communication unit 58 checks an incoming call at the frequency F (S520). The controller 56 determines whether to start communication (S522). When communication is not started (No in S522), control is returned to step 518. When communication is started (Yes in S522), the communication unit 58 performs the second and subsequent session of communication at the frequency F (S524). The second and subsequent sessions of communication are ended upon the transmission or reception of an end signal.

The communication unit 58 determines whether the value of the frequency F is the second frequency (S532). When the value of the frequency F is the second frequency (Yes in S532), the communication unit 58 returns to step 516, maintaining the value of the frequency F to be the second frequency. In other words, once the value of the frequency F is defined to be the second frequency, subsequent sessions of communication are always performed by using the second frequency. When the value of the frequency F is not the second frequency (No in S532), control is returned to step 512. In other words, even if the first and second sessions of communication are performed at the first frequency, subsequent sessions of communication are always performed by using the second frequency provided that the second frequency is available for use after the second session of communication is ended. When the timer has expired (Yes in S518), the controller 56 determines whether the user has turned off power (S534). When it is determined that the user has turned off power (Yes in S534), the process is ended. When it is not determined that the user has turned off power (No in S534), control is returned to step 502. In other words, a series communication formed by a plurality of sessions of communication is ended, and the system returns to the initial state.

According to the embodiment, a determination as to whether the second frequency is available for use is made when the first session of communication using the first frequency is ended. When the second frequency is available for use, the second session of communication is performed by using the second frequency. Accordingly, two frequencies can be used. Further, since two frequencies are used, the efficiency of using frequencies is improved. Further, since two frequencies are used, two sets of direction communication can be performed. Further, since the first frequency is used in the first session of communication, the standby process is performed by using only one frequency. Further, since the standby process is performed by using only one frequency, the standby process is simplified. Further, since a determination as to whether the second frequency is available for use is made when the second session of communication using the first frequency is ended, and, when the second frequency is available for use, the second frequency is used to perform the third session of communication, the efficiency of using frequencies is improved. Further, when it is determined that the second frequency is available for use, timer measurement is started, and the second frequency is used in a communication session started before the timer expires. Therefore, the period of time that the second frequency is available for use can be limited. Further, since the period of time that the second frequency is available for use is limited, the impact on other communication is reduced.

Described above is an explanation based on an exemplary embodiment. The embodiment is intended to be illustrative only and it will be understood by those skilled in the art that various modifications to constituting elements and processes could be developed and that such modifications are also within the scope of the present invention.

According to the embodiments, the communication system 100 uses business wireless communication. However, the type of communication that the communication system uses is not limited, and wireless communication systems other than the business wireless system may be used. According to this variation, the flexibility of the configuration is improved.

What is claimed is:

1. A wireless device comprising:
a communication unit that performs, in a state where communication is not being performed, a first session of communication by using a first frequency; and
a determination unit that determines whether a second frequency different from the first frequency is available for use after the first session of communication in the communication unit is ended, wherein
when the determination unit determines that the second frequency is available for use, the communication unit uses the second frequency to perform a second session of communication, and, when the determination unit determines that the second frequency is not available for use, the communication unit uses the first frequency to perform the second session of communication.

2. The wireless device according to claim 1, wherein
the determination unit determines whether the second frequency is available for use after the second session of communication using the first frequency is ended in the communication unit, and
when the determination unit determines that the second frequency is available for use, the communication unit uses the second frequency to perform a third session of communication, and, when the determination unit determines that the second frequency is not available for use, the communication unit uses the first frequency to perform the third session of communication.

3. The wireless device according to claim 1, further comprising:
a measurement unit that starts time measurement when the determination unit determines that the second frequency is available for use, and
when the determination unit determines that the second frequency is available for use, the communication unit uses the second frequency to start communication before a timer in the measurement unit expires and returns the device to a state where communication is not being performed when the timer in the measurement unit expires.

4. A communication method comprising:
performing, in a state where communication is not being performed, a first session of communication by using a first frequency;
determining whether a second frequency different from the first frequency is available for use after the first session of communication is ended;
using the second frequency to perform a second session of communication when it is determined that the second frequency is available for use; and
using the first frequency to perform the second session of communication when it is determined that the second frequency is not available for use.
